(19) United States
(12) Patent Application Publication
(10) Pub. No.: US 2024/0131660 A1
(43) Pub. Date: Apr. 25, 2024

(54) HIGH-IMPACT FASTENERS IN SOLAR APPLICATIONS

(71) Applicant: ARRAY TECH, INC., Albuquerque, NM (US)

(72) Inventors: Nathan Schuknecht, Golden, CO (US); Shuo Chen, Chandler, AZ (US); Kevin Krautbauer, Phoenix, AZ (US); Benjamin de Fresart, Chandler, AZ (US); Thierry Marin-Martinod, Chandler, AZ (US)

(21) Appl. No.: 18/493,168

(22) Filed: Oct. 23, 2023

Related U.S. Application Data
(60) Provisional application No. 63/381,920, filed on Nov. 1, 2022.
(60) Provisional application No. 63/380,736, filed on Oct. 24, 2022.

(51) Int. Cl. B25B 19/00; B25B 29/00

(52) U.S. Cl. CPC B25B 19/00; B25B 29/00

(57) ABSTRACT

Systems and methods for using high-impact fasteners to couple components of a solar power system together to prevent these components from any movement or slippage relative to each other. A strap may be secured over a top surface of the high-impact fasteners and around the components to prevent a disengagement of the high-impact fastener from the components and a separation of the components.

### CROSS-REFERENCE TO RELATED APPLICATIONS

This application claims priority under 35 U.S.C. § 119 to U.S. Provisional Application No. 63/380,736, filed Oct. 24, 2022, and U.S. Provisional Application No. 63/381,920, filed on Nov. 1, 2022, the entire disclosures of which are incorporated herein by reference.

### TECHNICAL FIELD

The embodiments discussed in the present disclosure are related to high-impact fasteners that are used in solar power systems and other solar applications.

### BACKGROUND

Solar power systems are becoming an increasingly popular way to generate energy. Some solar power systems are tracking systems that increase energy production by rotating photovoltaic (PV) modules to track a location of the Sun throughout the day. Other solar power systems are fixed systems in which the PV modules remain stationary.

Regardless of type, solar power systems include a variety of different components. In addition to PV modules, solar power systems often include piles that are driven into the ground and support structures, such as torque tubes, that are secured to the piles through interfaces. In tracking systems, these interfaces may include bearings and bearing housings that allow the torque tube or other mounting structure to rotate relative to the pile. In fixed systems, the interfaces secure the torque tube or other mounting structure to a pile in a way that does not allow movement between the mounting structures and the piles. PV modules are often mounted to the support structures through one or more mounting elements.

A variety of different coupling mechanisms are used to connect the various components of solar power systems together. Coupling mechanisms may include brackets, clamps, straps, and other mechanisms that can be selectively expanded/compressed or loosened/tightened in order to create friction connections between components. Coupling mechanisms may also include screws and bolts.

Once installed at a solar site, components in a solar power system may be exposed to a significant amount of stress from a number of different sources. Stress on components may be caused by the weight of the components themselves, the topography of the solar site, and environmental conditions, to name a few. For example, if terrain on which a solar power system is installed is not flat, certain components may experience higher stress. In addition, snow/ice buildup, wind, and seismic activity may also create significant stress on components. Stresses borne by tracking systems may be more significant as the PV modules rotate and centers of gravity shift from one side of a torque tube to another.

If the amount of stress is sufficient, components in solar power systems may fail. For example, brackets, clamps, straps, and other mechanisms that create friction connections between components may allow some movement or “slippage” between the components that they connect. For example, a mounting element that secures a PV module to a torque tube may slip laterally, along the length of the torque tube. Alternatively, the mounting element may slip rotationally, or radially around an outer perimeter of the torque tube so that the angular orientation of the PV module relative to the torque tube changes.

While screws and bolts may not allow slippage between the components that they connect, these coupling mechanisms require holes to be pre-drilled into components as part of the installation process. Drilling holes in correct locations and ensuring that components align precisely increases the cost and complexity of the installation process.

Accordingly, there is a need for a coupling mechanism that does not require pre-drilled holes and that prevents slippage between components in solar power systems.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address the problems experienced in solar tracking systems, including problems associated with slippage between components when coupling mechanisms fail due to stress. Disclosed embodiments address such issues by providing a coupling mechanism that avoids slippage and does not require the pre-drilling of holes as part of the installation process.

Specifically, one embodiment of the present disclosure includes a high-impact fastener that extends through a portion of a first component and a portion of a second component in a solar power system to prevent any movement or slippage between the first and second components. In another embodiment of the present disclosure, methods for assembling solar power systems are provided. According to one method, a first component of a solar power system is positioned proximate to a second component of the solar power system and a high-impact fastener is driven through a portion of the first component and through a portion of the second component using an actuated fastener device to prevent slippage between the first and second components.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIGS. 1A and 1B illustrate an actuated fastener device driving a high-impact fastener into components of a solar power system;

FIGS. 2A and 2B illustrate an example of high-impact fasteners that have been driven through components of a solar power system;

FIGS. 3A and 3B illustrate another example of high-impact fasteners that have been driven through components of a solar power system;

FIGS. 4A-4C illustrate another example of a high-impact fastener that has been driven through components of a solar power system;

FIG. 5 illustrates another example of high-impact fasteners that have been driven through components of a solar power system;

FIG. 6 illustrates another example of high-impact fasteners that have been driven through components of a solar power system; and

FIG. 7 a flowchart of an example method for assembling a solar power system using one or more high-impact fasteners.

### DETAILED DESCRIPTION

Systems and methods of the present disclosure use high-impact fasteners to couple components of a solar power system together to prevent these components from any movement or slippage relative to each other. High-impact fasteners are not screws; they are not inserted into or through components via a twisting or rotating motion. Because high-impact fasteners do not function like screws, they lack the threads that facilitate insertion of screws into and through materials. Rather, high-impact fasteners of the present disclosure rely on an external force to drive the high-impact fasteners into and through materials. High-impact fasteners described in the present disclosure may include common nails, finishing nails, box nails, casing nails, ring nails, spiral shank nails, roofing nails, masonry nails, flat head fastener, button head fasteners, panhead fasteners, to name a few.

In some embodiments, an actuated fastener device may be used to drive a high-impact fastener through one or more components of a solar power system. The actuated fastener device may include a powder-actuated fastener device, a gas-actuated fastener device, or an electronically actuated fastener device. The powder-actuated fastener device may use a gunpowder charge (e.g., a black powder charge) to actuate a piston to drive the high-impact fastener into the components. In some embodiments, the powder-actuated fastener device may drive the high-impact fastener into the components including steel with a thickness that is equal to or greater than ⅜ an inch. The gas actuated fastener device may use a combustible gas (e.g., propane, gasoline) to actuate the piston to drive the high-impact fastener into the components. The electronically actuated device may use an electric motor that loads and releases a spring (e.g., a spring force) to actuate the piston to drive the high impact fastener into the components.

In some embodiments, the actuated fastener device may be configured to apply an impact force at a level equal to one hundred twenty-five joules. In other embodiments, the actuated fastener device may be configured to apply an impact force at a level equal to one hundred fifty joules. Alternatively or additionally, the actuated fastener device may be configured to apply an impact force at a level equal to three hundred thirty-five joules. In these and other embodiments, the actuated fastener device may be configured to apply an impact force at a level equal to or greater than one hundred joules.

The actuated fastener device may drive a high-impact fastener through components of a solar power system without drilling holes or perforating the components prior to driving the high-impact fastener therethrough. The actuated fastener device may also permit the components to be attached without any prior knowledge of the installation configuration of the solar power system (e.g., without prior knowledge of a type of the PV module, an installation site, and mounting dimensions of the PV module).

While high-impact fasteners of the present disclosure may prevent two or more components in a solar power system from slippage, high-impact fasteners can disengage from one or both of the components through which they have been driven, especially if the components are exposed to high levels of stress. For example, if the high-impact fastener is turned upside down so that the head of the high-impact fastener is closest to the ground, gravity may pull the fastener out of one or both components. Thus, a strap that covers a top surface of the high-impact fastener and surrounds all or part of the two or more components may be used to prevent a disengagement of the high-impact fastener from the two or more components.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

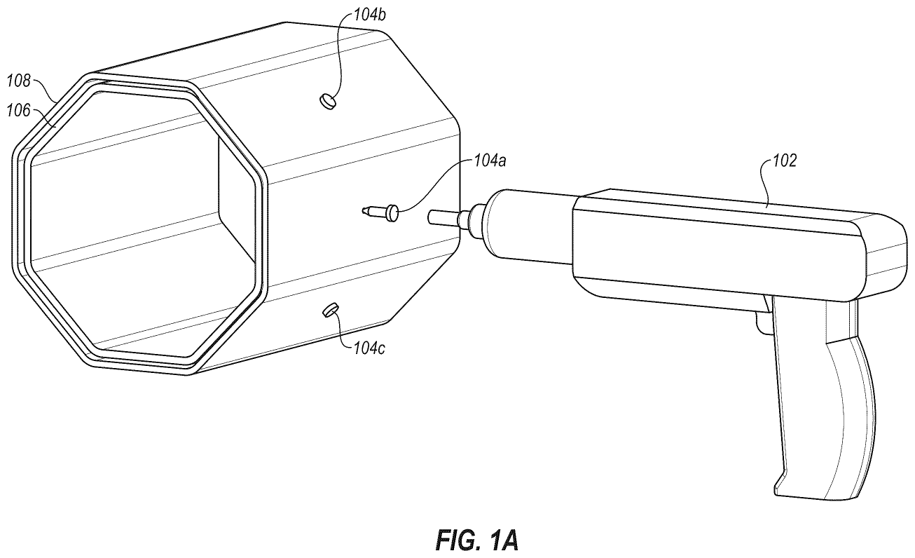

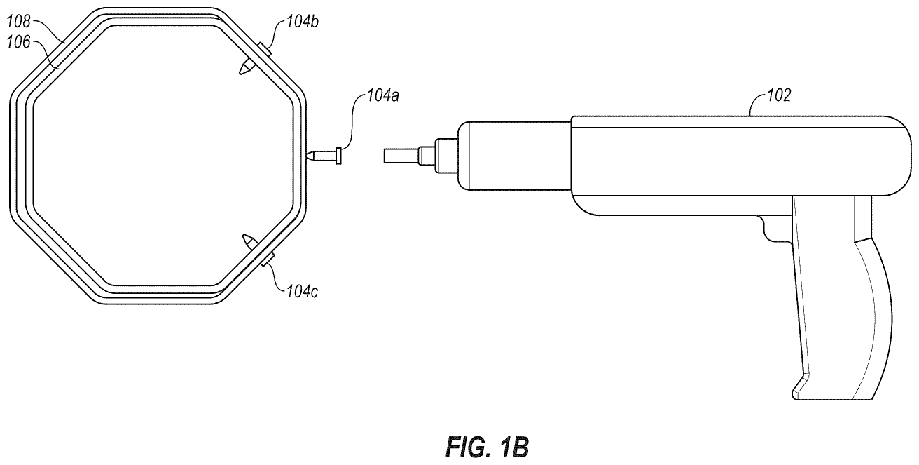

FIGS. 1A and 1B illustrate an example actuated fastener device 102 driving a high-impact fastener 104a into an internal torque tube segment 106, and an external torque tube segment 108, in accordance with at least one embodiment described in the present disclosure. FIGS. 1A and 1B also illustrate high-impact fasteners 104b and 104c that have already been driven through the internal and external torque tube segments 106 and 108. The actuated fastener device 102 may include a powder-actuated fastener device, gas-actuated fastener device, or an electrically actuated fastener device.

A powder actuated fastener device may include a firing pin that strikes a charge of gunpowder to cause a combustion of the gunpowder to drive a piston. The piston may be driven towards an end of the actuated fastener device and toward the torque tube segments 106 and 108. The piston may apply impact force on the high-impact fastener 104a sufficient to drive the high-impact fastener 104a through material of the internal and external torque tube segments 106 and 108. When driven through, the high-impact fastener 104a may prevent the internal torque tube segment 106 from moving or slipping relative the external torque tube segment 108.

A gas-actuated fastener device may include a spark plug that generates a spark to ignite gas within a combustion chamber to drive a piston. In some embodiments, the gas may be under pressure, may be aerosolized, mixed with air, or otherwise processed to facilitate combustion of the gas. The piston may apply impact force on the high-impact fastener 104a sufficient to drive the high-impact fastener 104a through material of the internal and external torque tube segments 106 and 108. When driven through, the high-impact fastener 104a may prevent the internal torque tube segment 106 from moving or slipping relative the external torque tube segment 108.

An electrically actuated fastener device may include a motor that causes a spring-loaded leadscrew to move to load and release springs (e.g., load and release spring forces) to drive a piston. The piston may apply impact force on the high-impact fastener 104a sufficient to drive the high-impact fastener 104a through material of the internal and external torque tube segments 106 and 108. When driven through, the high-impact fastener 104a may prevent the internal torque tube segment 106 from moving or slipping relative the external torque tube segment 108.

In some embodiments, the actuated fastener device 102 may include a silencer to reduce a decibel level of one or more of the combustion of the gunpowder or gas, the piston striking the high-impact fastener 104, the high-impact fastener 104 puncturing the torque tube segments 106 and 108, or any other aspects of the operation of the actuated fastener device. The silencer may reduce an impact to hearing of a user of the actuated fastener device.

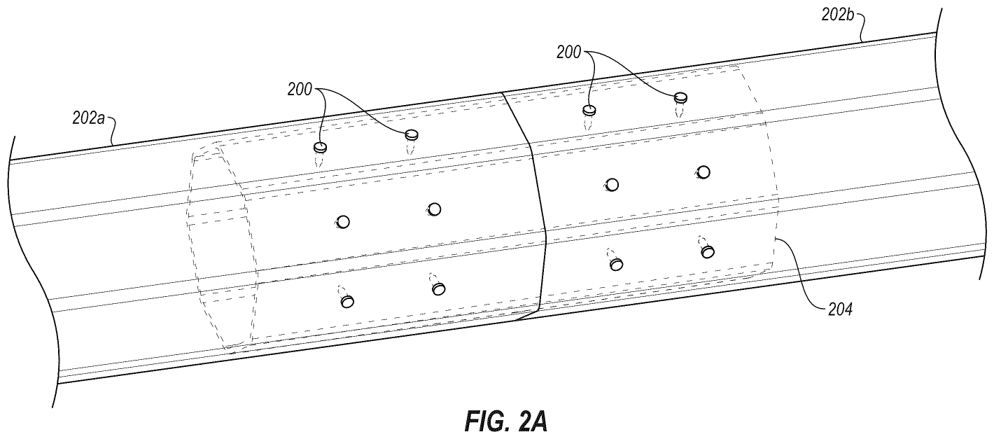

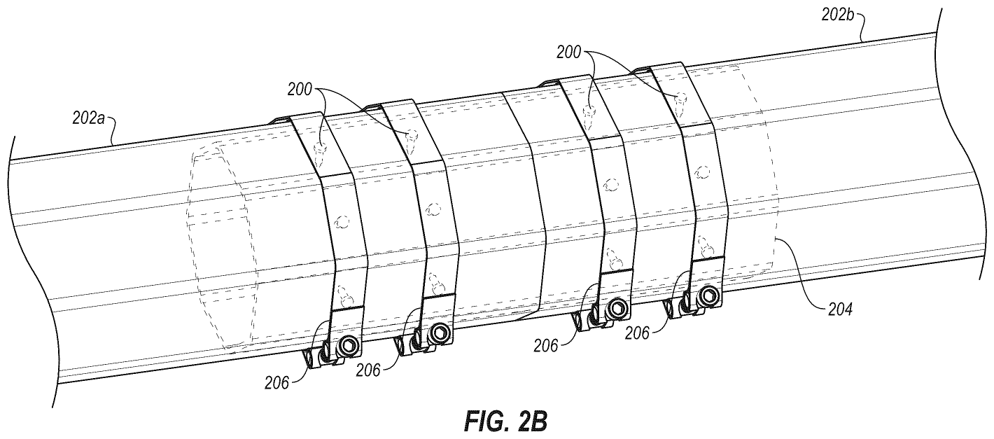

FIGS. 2A and 2B illustrate high-impact fasteners 200 that have been driven through a first torque tube segment 202a, a second torque tube segment 202b, and an internal torque tube coupler 204. The internal torque tube coupler 204 may connect the first torque tube segment 202a to the second torque tube segment 202b. Any number of fasteners 200 may be used to secure these components together. The fasteners 200 may prevent the torque tube segments 202a and 202b from moving laterally relative to the internal torque tube coupler 204.

FIG. 2B illustrates straps 206. The straps 206 are secured over top surfaces of the high-impact fasteners 200 to prevent a disengagement of the high-impact fasteners 200 from the first and second torque tube segments 202a and 202b and the internal torque tube coupler 204. The straps 206 thus prevent the first and second torque tube segments 202a and 202b from separating from the internal torque tube coupler 204.

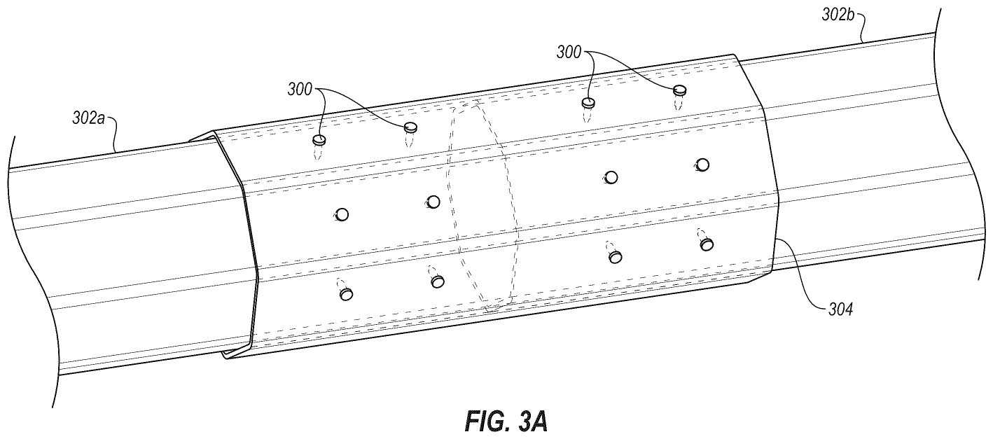

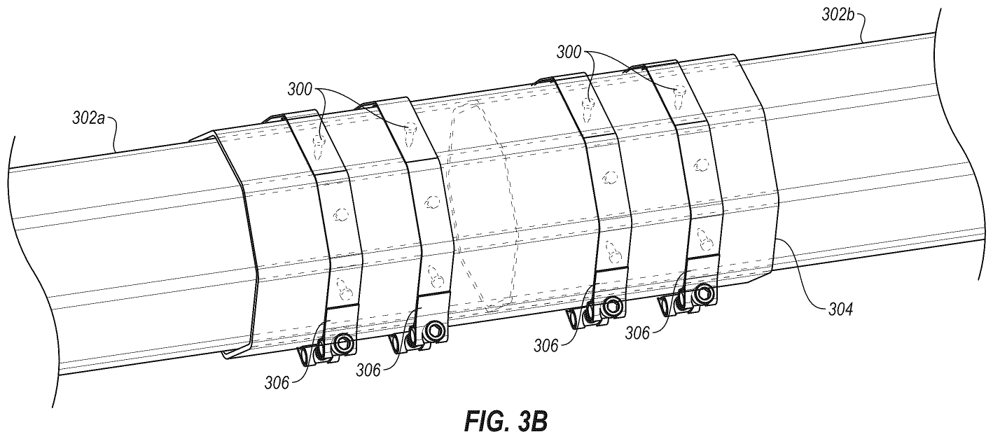

FIGS. 3A and 3B illustrate high-impact fasteners 300 that have been driven through a first torque tube segment 302a, a second torque tube segment 302b, and an external torque tube coupler 304. The external torque tube coupler 304 may connect the first torque tube segment 302a to the second torque tube segment 302b. Any number of fasteners 300 may be used to secure these components together. The fasteners 300 may prevent the torque tube segments 302a and 302b from moving laterally relative to the external torque tube coupler 304.

FIG. 3B illustrates straps 306. The straps 306 are secured over top surfaces of the high-impact fasteners 300 to prevent a disengagement of the high-impact fasteners 300 from the first and second torque tube segments 302a and 302b and the external torque tube coupler 304. The straps 306 thus prevent the first and second torque tube segments 302a and 302b from separating from the external torque tube coupler 304.

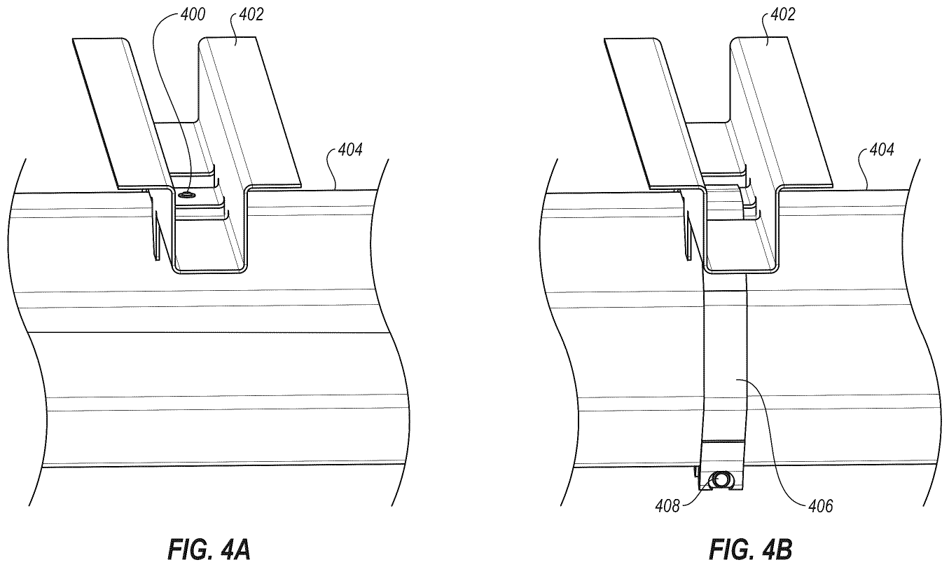

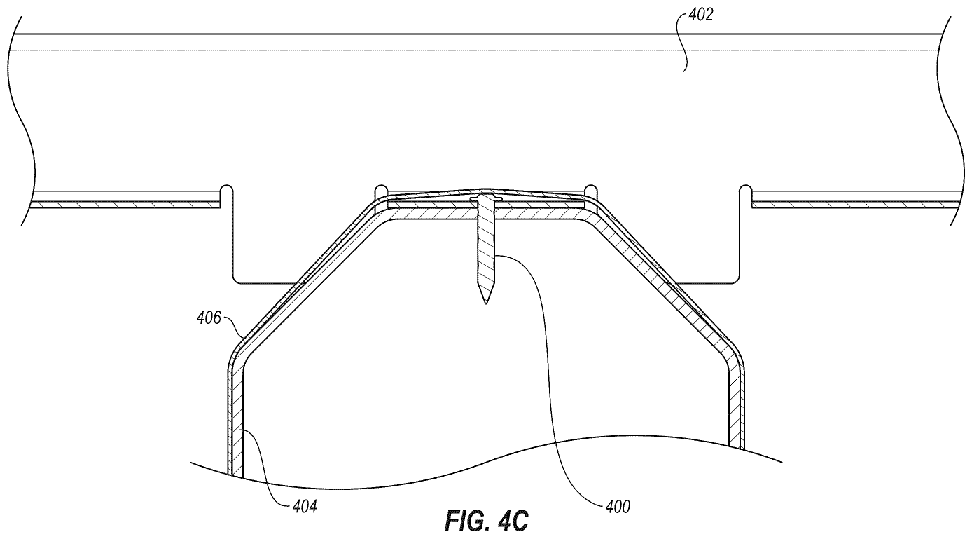

FIGS. 4A-4C illustrate a high-impact fastener 400 that has been driven through a mounting element 402 and torque tube 404. The mounting element 402 is configured to be attached to a photovoltaic (PV) module (not shown). A strap 406 that is secured over the top of the high-impact fastener 400 and around the torque tube 404 is illustrated in FIGS. 4B and 4C. As can be seen in FIG. 4B, the strap 406 includes a tightening mechanism 408 that can selectively increase the tension of the strap 406 to prevent the high-impact fastener from a disengaging from the mounting element 402 and torque tube 404. The strap 406 thus prevents the mounting element 402 from separating from the torque tube 404.

FIG. 4C is a cross sectional view of the high-impact fastener 400, the mounting element 402, the torque tube 404, and the strap 406. As can be seen, the strap 406 is secured over the top of the high-impact fastener 400 and around a portion of the mounting element 402. The strap 406 also surrounds a perimeter surface of the torque tube 404.

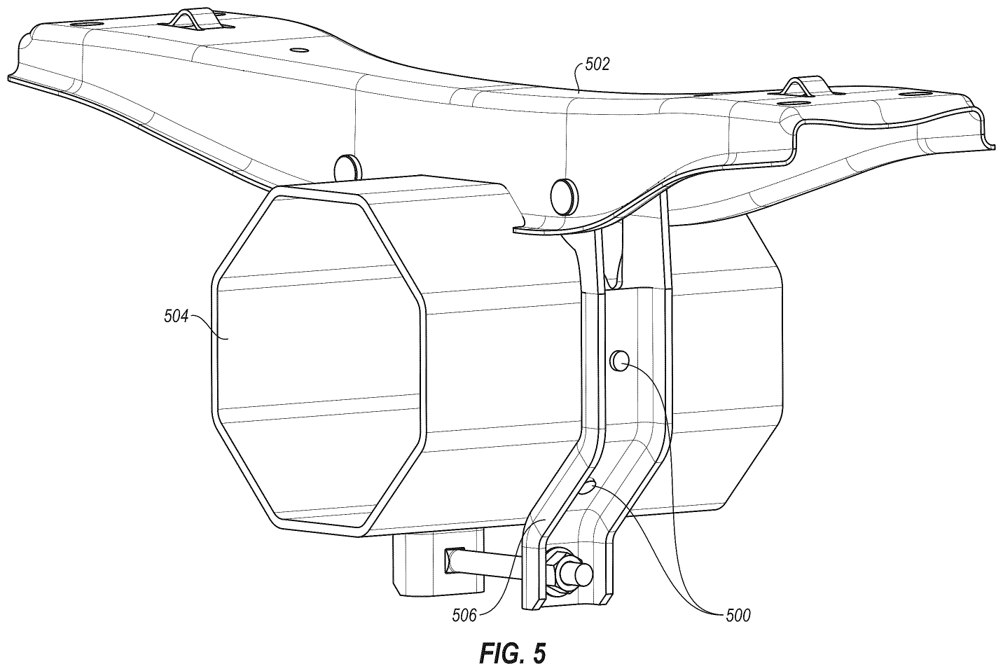

FIG. 5 illustrates high-impact fasteners 500 that have been driven through a mounting element 502 and a torque tube 504. The mounting element 502 in this embodiment includes brackets 506 that couple the mounting element 502 to the torque tube 504. The high-impact fasteners 500 have been driven through the brackets 506 and the torque tube 504. The high-impact fasteners 500 prevent the mounting element 502 from slipping relative to the torque tube 504. The slipping prevented by the high-impact fasteners 500 includes lateral slipping (in the direction of the torque tube 504) and rotational slipping (radially around the torque tube 504).

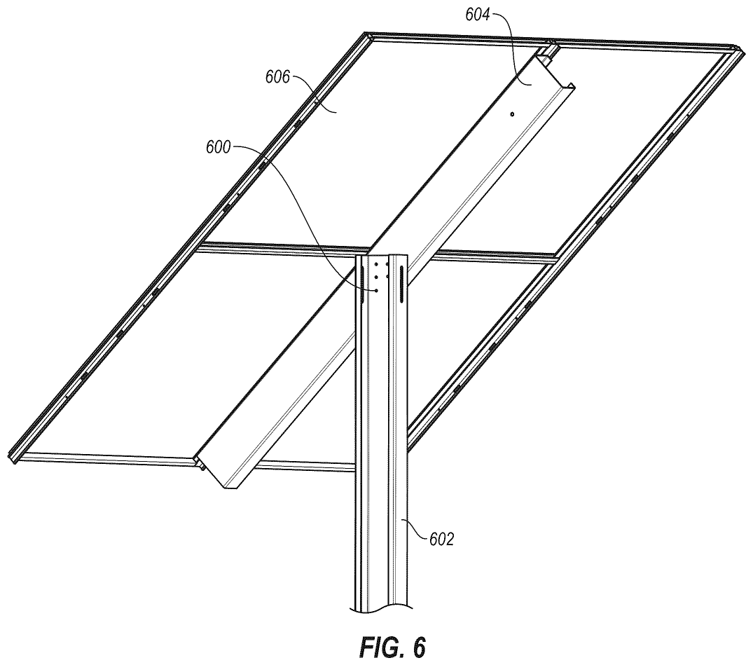

FIG. 6 illustrates high-impact fasteners 600 in a fixed-tilt solar system. The high-impact fasteners 600 have been driven through a pile 602 and a module rail 604. The pile 602 and module rail 604 have cross-sectional C-shapes and the module rail 604 is secured to a PV module 606.

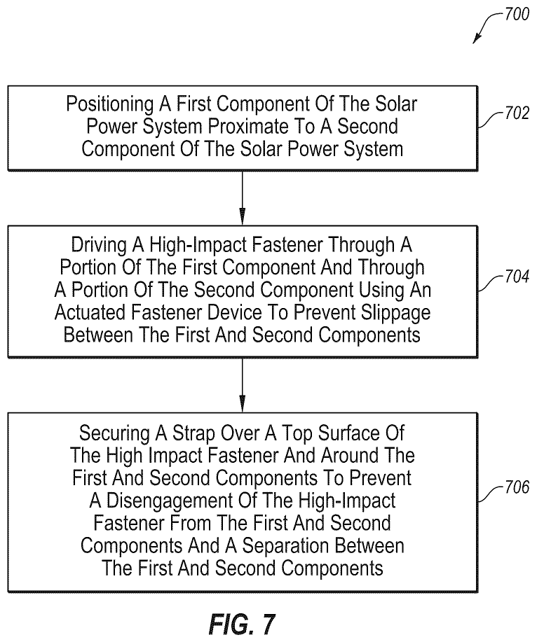

FIG. 7 a flowchart of an example method 700 for assembling a solar power system using one or more high-impact fasteners. The method 700 may include, at action 702, positioning a first component of the solar power system proximate to a second component of the solar power system. The first and second components could be any number of different components used in solar power systems. For example, one or both of the first and second components could include PV modules, piles, support structures, torque tube interfaces and mounting elements. In one embodiment, the first component may be a support structure (such as a torque tube) and the second component may be a mounting element.

The method 700 may include, at action 704, driving a high-impact fastener through a portion of the first component and through a portion of the second component using an actuated fastener device to prevent slippage between the first and second components. In some embodiments, the portions of the first and second components may lack any holes or perforations prior to the high-impact fastener being driven through the first and second components. In one embodiment, the actuated fastener device may be a powder actuated fastener device. In another embodiment, the actuated fastener device may be a gas actuated fastener device. In another embodiment, the actuated fastener device may be an electronically actuated fastener device.

In some embodiments, the actuated fastener device may be configured to drive the high-impact fastener through a portion of a first component of a solar power system and a portion of a second component of the solar power system to attach the first component to the second component. In some embodiments, the actuated fastener device may be configured to apply an impact force equal to or greater than one hundred joules. In another embodiment, the actuated fastener may be configured to apply an impact force at a level of approximately one hundred fifty joules. In another embodiment, the actuated fastener may be configured to apply an impact force at a level of approximately three hundred thirty-five joules.

The method 700 may include, at action 706, securing a strap over a top surface of the high-impact fastener and around the first and second components to prevent a disengagement of the high-impact fastener from the first and second components and a separation between the first and second components.

Terms used in the present disclosure and especially in the appended claims (e.g., bodies of the appended claims) are generally intended as “open terms” (e.g., the term “including” should be interpreted as “including, but not limited to.”).

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of assembling a solar power system, the method comprising:
positioning a first component of the solar power system proximate to a second component of the solar power system; and
driving a high-impact fastener through a portion of the first component and through a portion of the second component using an actuated fastener device to prevent slippage between the first and second components.

2. The method of claim 1, further comprising:
securing a strap over a top surface of the high-impact fastener and around the first and second components to prevent a disengagement of the high-impact fastener from the first and second components and a separation between the first and second components.

3. The method of claim 1, wherein the portions of the first and second components lack any holes or perforations prior to the high-impact fastener being driven through the first and second components.

4. The method of claim 1, wherein the first component is a support structure and the second component is a mounting element.

5. The method of claim 4, wherein the support structure is a torque tube.

6. The method of claim 1, wherein the actuated fastener device comprises a powder actuated fastener device.

7. The method of claim 1, wherein the actuated fastener device comprises a gas actuated fastener device.

8. The method of claim 1, wherein the actuated fastener device comprises an electronically actuated fastener device.

9. The method of claim 1, wherein the actuated fastener device is configured to drive the high-impact fastener through a portion of a first component of a solar power system and a portion of a second component of the solar power system to attach the first component to the second component.

10. The method of claim 1, wherein the actuated fastener device is configured to apply an impact force equal to or greater than one hundred joules.

11. The method of claim 10, wherein the actuated fastener is configured to apply an impact force at a level of approximately one hundred fifty joules.

12. The method of claim 10, wherein the actuated fastener is configured to apply an impact force at a level of approximately three hundred thirty-five joules.

13. A solar power system comprising:
a first component;
a second component; and
a high-impact fastener extending through a portion of the first component and through a portion of the second component to prevent slippage between the first and second components.

14. The system of claim 13, further comprising:
a strap secured over a top surface of the high-impact fastener and around the first and second components to prevent a disengagement of the high-impact fastener from the first and second components and a separation between the first and second components.

15. The system of claim 13, wherein the first component is a support structure and the second component is a mounting element.

16. The system of claim 15, wherein the support structure is a pile.

17. The system of claim 15, wherein the support structure is a torque tube.

18. The system of claim 17, further comprising a PV module that is secured to the torque tube through the mounting element.

19. The system of claim 13, wherein the first component is a torque tube and the second component is an internal torque tube coupler.

20. The system of claim 13, wherein the first component is a torque tube and the second component is an external torque tube coupler.
